(19) United States
(12) Patent Application Publication
(10) Pub. No.: US 2019/0047586 A1
(43) Pub. Date: Feb. 14, 2019

(54) VEHICLE CONTROL APPARATUS, VEHICLE, VEHICLE CONTROL METHOD, AND STORAGE MEDIUM

(71) Applicant: HONDA MOTOR CO., LTD., Tokyo (JP)

(72) Inventor: Yoshinori Sekine, Tokyo (JP)

(21) Appl. No.: 16/052,839

(22) Filed: Aug. 2, 2018

(30) Foreign Application Priority Data
Aug. 14, 2017 (JP) 2017-156632

(51) Int. Cl. B60W 50/12

(52) U.S. Cl. CPC B60W 50/12; B60W 2540/28; B60W 2540/04

(57) ABSTRACT

A vehicle control apparatus that controls traveling of a vehicle based on an automated driving function includes an input unit configured to input code information issued after a user of the vehicle confirms an explanation about the automated driving function, an approval unit configured to approve the code information based on comparison between the input code information and registration information registered in a server on a network, and a control unit configured to control, in a state before the approval of the code information, the vehicle in a state in which the automated driving function of the vehicle is partially restricted, and control automated driving traveling of the vehicle by canceling the restriction of the automated driving function after the approval of the code information.

### BACKGROUND OF THE INVENTION

### Field of the Invention

The present invention relates to a vehicle control apparatus, a vehicle, a vehicle control method, and a storage medium and, more particularly, to a vehicle control technique for controlling an automated driving car.

### Description of the Related Art

As for a vehicle having an automated driving function, a purchaser of the vehicle needs to receive a prior explanation for correctly understanding various operation conditions and the like associated with the automated driving function of the vehicle, and confirm or approve explanation contents.

Upon receiving the prior explanation and approving it, an approval code is generated on a system, and the automated driving function is configured to effectively operate based on the approval code.

As an arrangement of changing the function of an apparatus based on the approval code on the system, Japanese Patent Laid-Open No. 2000-357157 discloses an arrangement of determining, among a plurality of communication devices, whether a reception side can receive an authentication code transmitted from a transmission side, and changing an operation mode in accordance with a determination result.

However, Japanese Patent Laid-Open No. 2000-357157 does not disclose a function restriction in an automated driving vehicle and an arrangement of canceling the function restriction based on the authentication code.

### SUMMARY OF THE INVENTION

The present invention provides a vehicle control technique capable of controlling, in a state before approval of an authentication code, a vehicle in a state in which the automated driving function of the vehicle is partially restricted, and controlling automated driving traveling of the vehicle by canceling the restriction of the automated driving function after approval of code information.

According to one aspect of the present invention, there is provided a vehicle control apparatus that controls traveling of a vehicle based on an automated driving function, comprising: an input unit configured to input code information issued after a user of the vehicle confirms an explanation about the automated driving function; an approval unit configured to approve the code information based on comparison between the input code information and registration information registered in a server on a network; and a control unit configured to control, in a state before the approval of the code information, the vehicle in a state in which the automated driving function of the vehicle is partially restricted, and control, after the approval of the code information, automated driving traveling of the vehicle by canceling the restriction of the automated driving function.

According to the present invention, it is possible to control, in a state before approval of an authentication code, a vehicle in a state in which the automated driving function of the vehicle is partially restricted, and control automated driving traveling of the vehicle by canceling the restriction of the automated driving function after approval of code information.

Further features of the present invention will become apparent from the following description of exemplary embodiments (with reference to the attached drawings).

### BRIEF DESCRIPTION OF THE DRAWINGS

FIG. 1A is a block diagram showing the basic arrangement of a vehicle control apparatus;

FIG. 1B is a view showing an example of the arrangement of control blocks for controlling a vehicle;

FIG. 2 is a flowchart for explaining a schematic procedure of canceling a function restriction of an automated driving function;

FIG. 3 is a flowchart for explaining a procedure of canceling the function restriction of the automated driving function;

FIG. 4 is a flowchart for explaining the procedure of processing of canceling approval of code information;

FIG. 5 is a flowchart for explaining the procedure of processing by the vehicle control apparatus according to an embodiment;

FIG. 6 is a flowchart for explaining the procedure of the processing by the vehicle control apparatus according to the embodiment;

FIG. 7 is a flowchart for explaining the procedure of the processing by the vehicle control apparatus according to the embodiment; and

FIG. 8 is a flowchart for explaining the procedure of the processing by the vehicle control apparatus according to the embodiment.

### DESCRIPTION OF THE EMBODIMENTS

An embodiment of the present invention will be described below with reference to the accompanying drawings. The constituent elements described in the embodiments are merely examples. The present invention is not limited by the following embodiments.

(Arrangement of Vehicle Control Apparatus)

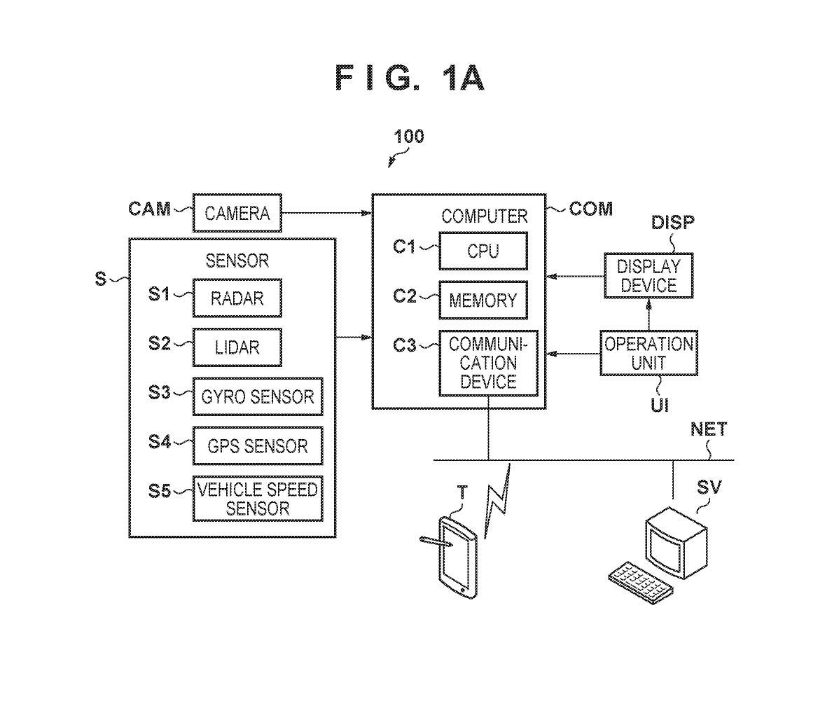

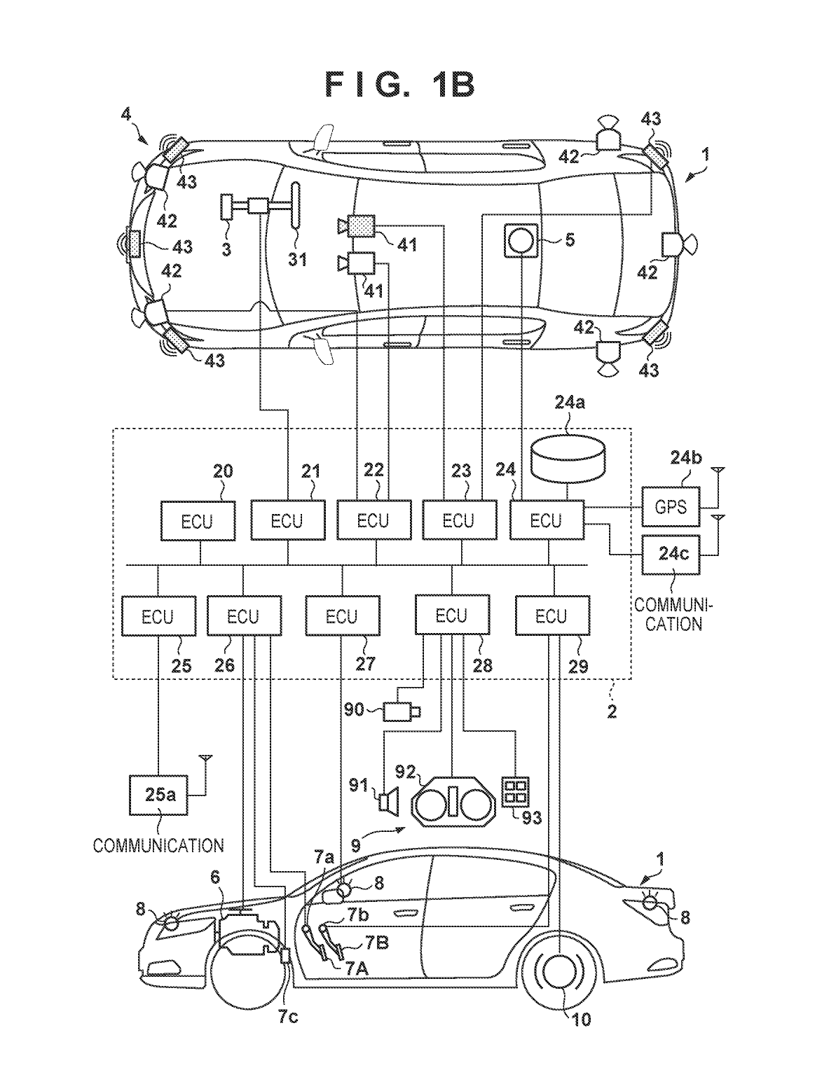

FIG. 1A is a block diagram exemplifying the basic arrangement of a vehicle control apparatus 100 that controls automated driving of a vehicle. The vehicle control apparatus 100 includes a sensor S, a camera CAM, a computer COM, a display device DISP, and an operation unit UI that functions as an operation input unit for operating the display device DISP. The sensor S includes, for example, a radar S1, a lidar S2, a gyro sensor S3, a GPS sensor S4, and a vehicle speed sensor S5.

The computer COM includes a CPU C1 that controls processing associated with automated driving control of the vehicle, a memory C2, and a communication device C3 that is connected to a network NET to be communicable with a server SV or another external terminal T on the network. The sensor S and the camera CAM acquire various kinds of information of the vehicle, and input them to the computer COM.

The computer COM can perform image processing for the pieces of information input from the sensor S (radar S1 and lidar S2) and the camera CAM, thereby extracting a target (object) existing around a vehicle 1 (self-vehicle) according to this embodiment. The computer COM extracts a target from an image acquired by the sensor S (radar S1 and lidar S2) and the camera CAM, and analyzes a specific target arranged around the vehicle 1.

The gyro sensor S3 can detect the rotary motion and orientation of the vehicle 1. The computer COM can determine the course of the vehicle 1 based on the detection result of the gyro sensor S3, a vehicle speed detected by the vehicle speed sensor S5, and the like. The GPS sensor S4 detects the current position (position information) of the vehicle 1 in map information.

The vehicle control apparatus 100 can control traveling of the vehicle using the pieces of information of the sensor S and the camera CAM based on the automated driving function. As for the vehicle having the automated driving function, the user (driver) of the vehicle needs to receive a prior explanation for correctly understanding various operation conditions and the like associated with the automated driving function of the vehicle, and confirm or approve explanation contents. Upon receiving the prior explanation and approving it, code information for approval is issued on a system, and the automated driving function is configured to effectively operate based on the code information.

For example, if the user starts learning by inputting vehicle information using the external terminal T or the display device DISP functioning as an in-vehicle monitor, and confirmation of explanation contents is complete, the server SV issues code information. This code information is input to the vehicle control apparatus 100 via the network NET. The communication device C3 functions as an information input unit, and inputs the code information issued after the user of the vehicle confirms the explanation about the automated driving function.

The display device DISP can display information concerning the prior explanation about the automated driving function, the code information, and information concerning a function restriction of the automated driving function. For example, the display device DISP can be formed by a touch panel, and the display device DISP and the operation unit UI can be formed integrally.

If the vehicle control apparatus 100 shown in FIG. 1A is mounted on the vehicle, the computer COM may be arranged in an ECU of an image processing system or an ECU of a recognition processing system, that processes the pieces of information of the sensor S and the camera CAM, an ECU that controls a communication device or an input/output device, an ECU in a control unit that controls driving of the vehicle, or an ECU for automated driving. For example, as shown in FIG. 1B to be described below, functions may be distributed to the plurality of ECUs constituting the vehicle control apparatus 100, such as an ECU for the sensor S, an ECU for the camera, an ECU for the input/output device, and an ECU for automated driving.

FIG. 1B is a view showing an example of the arrangement of the control blocks of the vehicle control apparatus 100 for controlling the vehicle 1. Referring to FIG. 1B, an outline of the vehicle 1 is shown in a plan view and a side view. As an example, the vehicle 1 is a sedan-type four-wheeled vehicle.

A control unit 2 shown in FIG. 1B controls each unit of the vehicle 1. The control unit 2 includes a plurality of ECUs 20 to 29 communicably connected by an in-vehicle network. Each ECU (Engine Control Unit) includes a processor represented by a CPU (Central Processing Unit), a storage device such as a semiconductor memory, and an interface with an external device. The storage device stores programs to be executed by the processor, data to be used by the processor for processing, and the like. Each ECU may include a plurality of processors, storage devices, and interfaces.

The functions and the like provided by the ECUs 20 to 29 will be described below. Note that the number of ECUs and the provided functions can appropriately be designed for the vehicle 1, and they can be subdivided or integrated as compared to this embodiment.

The ECU 20 executes vehicle control associated with automated driving of the vehicle 1 (self-vehicle) according to this embodiment. In automated driving, at least one of steering and acceleration/deceleration of the vehicle 1 is automatically controlled. Processing for practical control associated with automated driving will be described in detail later.

In control of traveling of the vehicle, the ECU 20 controls automated driving traveling of the vehicle by setting an automated driving level based on the position of the vehicle 1 (self-vehicle) indicating the peripheral status of the vehicle, the relative position of another vehicle existing around the vehicle 1, map information or information of a road on which the vehicle 1 travels, and the like.

The automated driving level is operation control information classified into one of a plurality of stages in accordance with the control degree of the control unit (for example, the ECU 20) for an operation associated with acceleration, steering, and braking of the vehicle and the degree of participation of the driver, who operates the vehicle, in a vehicle operation. For example, examples of the automated driving level are as follows. Note that the following classification is merely an example, and the scope of the present invention is not limited to this.

(1) Level 1 (Independent Automated Driving)

In level 1, a traveling control apparatus controls one of acceleration, steering, and braking operations of the vehicle. The driver needs to participate in all but the operation controlled by the traveling control apparatus. In level 1, the driver is always required to be in a posture in which he/she can drive safely (the driver is required to perform a peripheral monitoring duty).

(2) Level 2 (Combining of Automated Driving)

In level 2, the traveling control apparatus controls a plurality of operations among the acceleration, steering, and braking operations of the vehicle. The degree of participation of the driver is lower than that in level 1. However, in level 2 as well, the driver is always required to be in a posture in which he/she can drive safely (the driver is required to perform the peripheral monitoring duty).

(3) Level 3 (Advancement of Automated Driving)

In level 3, the traveling control apparatus performs all of the acceleration, steering, and braking operations. Only when the traveling control apparatus makes a request, the driver operates the vehicle. In level 3, during traveling by automated driving, the driver is not required to perform the peripheral monitoring duty. In level 3, the degree of participation of the driver is further lower than that in level 2.

(4) Level 4 (Full Driving Automation)

In level 4, the traveling control apparatus performs all the acceleration, steering, and braking operations, and the driver does not participate in the operation of the vehicle at all. In level 4, the vehicle performs automated traveling in the entire traveling course, and the driver is not required to perform the peripheral monitoring duty during traveling by automated driving. In level 4, the degree of participation of the driver is further lower than that in level 3.

The following description assumes that the automated driving level in which the driver is required to perform the peripheral monitoring duty is a low automated driving level, and the automated driving level in which the driver is not required to perform the peripheral monitoring duty is a high automated driving level.

The ECU 21 controls an electric power steering device 3. The electric power steering device 3 includes a mechanism that steers front wheels in accordance with a driving operation (steering operation) of the driver on a steering wheel 31. In addition, the electric power steering device 3 includes a motor that generates a driving force to assist the steering operation or automatically steer the front wheels, and a sensor that detects the steering angle. If the driving state of the vehicle 1 is automated driving, the ECU 21 automatically controls the electric power steering device 3 in correspondence with an instruction from the ECU 20 and controls the traveling direction of the vehicle 1.

The ECUs 22 and 23 perform control of detection units 41 to 43 that detect the peripheral status of the vehicle and information processing of detection results. The detection unit 41 is, for example, a camera (to be sometimes referred to as the camera 41 hereinafter) that captures the front side of the vehicle 1. In this embodiment, two cameras 41 are provided on the roof front of the vehicle 1. When images captured by the cameras 41 are analyzed (image processing), the contour of a target or a division line (a white line or the like) of a lane on a road can be extracted.

The detection unit 42 (a lidar detection unit) is, for example, a lidar (laser radar) (to be sometimes referred to as the lidar 42 hereinafter), and detects a target around the vehicle 1 or measures the distance to a target using light. In this embodiment, a plurality of lidars 42 are provided around the vehicle. In the example shown in FIG. 1B, five lidars 42 are provided; one at each corner of the front portion of the vehicle 1, one at the center of the rear portion, and one on each side of the rear portion. The detection unit 43 (radar detection unit) is, for example, a millimeter wave radar (to be sometimes referred to as the radar 43 hereinafter), and detects a target around the vehicle 1 or measures the distance to a target using a radio wave. In this embodiment, a plurality of radars 43 are provided around the vehicle. In the example shown in FIG. 1B, five radars 43 are provided; one at the center of the front portion of the vehicle 1, one at each corner of the front portion, and one at each corner of the rear portion.

The ECU 22 performs control of one camera 41 and each lidar 42 and information processing of detection results. The ECU 23 performs control of the other camera 41 and each radar 43 and information processing of detection results. Since two sets of devices that detect the peripheral status of the vehicle are provided, the reliability of detection results can be improved. In addition, since detection units of different types such as cameras, lidars, and radars are provided, the peripheral environment of the vehicle can be analyzed in a multifaceted manner. Note that the ECUs 22 and 23 may be integrated into one ECU.

The ECU 24 performs control of a gyro sensor 5, a GPS sensor 24b, and a communication device 24c and information processing of detection results or communication results. The gyro sensor 5 detects a rotary motion of the vehicle 1. The course of the vehicle 1 can be determined based on the detection result of the gyro sensor 5, the wheel speed, or the like. The GPS sensor 24b detects the current position of the vehicle 1. The communication device 24c performs wireless communication with a server that provides map information or traffic information and acquires these pieces of information. The ECU 24 can access a map information database 24a formed in the storage device. The ECU 24 searches for a route from the current position to the destination. The database 24a can be arranged on the network, and the communication device 24c can acquire the information by accessing the database 24a on the network.

The ECU 25 includes a communication device 25a for inter-vehicle communication. The communication device 25a performs wireless communication with another vehicle on the periphery and performs information exchange between the vehicles.

The ECU 26 controls a power plant 6. The power plant 6 is a mechanism that outputs a driving force to rotate the driving wheels of the vehicle 1 and includes, for example, an engine and a transmission. The ECU 26, for example, controls the output of the engine in correspondence with a driving operation (accelerator operation or acceleration operation) of the driver detected by an operation detection sensor 7a provided on an accelerator pedal 7A, or switches the gear ratio of the transmission based on information such as a vehicle speed detected by a vehicle speed sensor 7c. If the driving state of the vehicle 1 is automated driving, the ECU 26 automatically controls the power plant 6 in correspondence with an instruction from the ECU 20 and controls the acceleration/deceleration of the vehicle 1.

The ECU 27 controls lighting devices (headlights, taillights, and the like) including direction indicators 8. In the example shown in FIG. 1B, the direction indicators 8 are provided in the front portion, door mirrors, and the rear portion of the vehicle 1.

The ECU 28 controls an input/output device 9. The input/output device 9 outputs information to the driver and accepts input of information from the driver. A voice output device 91 notifies the driver of the information by a voice. A display device 92 notifies the driver of information by displaying an image. The display device 92 is arranged on, for example, the surface of the driver's seat and constitutes an instrument panel or the like. Note that although a voice and display have been exemplified here, the driver may be notified of information using a vibration or light. Alternatively, the driver may be notified of information by a combination of some of the voice, display, vibration, and light. Furthermore, the combination or the notification form may be changed in accordance with the level (for example, the degree of urgency) of information of which the driver is to be notified.

An input device 93 is a switch group that is arranged at a position where the driver can perform an operation and used to issue an instruction to the vehicle 1, and may also include a voice input device. For example, the display device 92 corresponds to the display device DISP shown in FIG. 1A described above, and the input device 93 corresponds to the arrangement of the operation unit UI shown in FIG. 1A.

The ECU 29 controls a brake device 10 and a parking brake (not shown). The brake device 10 is, for example, a disc brake device which is provided for each wheel of the vehicle 1 and decelerates or stops the vehicle 1 by applying a resistance to the rotation of the wheel. The ECU 29, for example, controls the operation of the brake device 10 in correspondence with a driving operation (brake operation) of the driver detected by an operation detection sensor 7b provided on a brake pedal 7B. If the driving state of the vehicle 1 is automated driving, the ECU 29 automatically controls the brake device 10 in correspondence with an instruction from the ECU 20 and controls deceleration and stop of the vehicle 1. The brake device 10 or the parking brake can also be operated to maintain the stop state of the vehicle 1. In addition, if the transmission of the power plant 6 includes a parking lock mechanism, it can be operated to maintain the stop state of the vehicle 1.

In vehicle control according to this embodiment, the ECU 28 shown in FIG. 1B functions as an approval unit that performs approval processing based on the code information. That is, the ECU 28 (approval unit) approves the code information based on comparison between registration information registered in the server SV on the network and the code information input to the vehicle control apparatus 100. If the code information input to the vehicle control apparatus 100 matches the registration information registered in the server SV, the ECU 28 (approval unit) approves the code information.

The ECU 20 functions as a control unit that partially restricts the automated driving function and controls cancellation of the restriction based on the result of approving the code information by the ECU 28 (approval unit). The ECU 20 (control unit) controls, in a state before the approval of the code information by the ECU 28 (approval unit), the vehicle 1 in a state in which the automated driving function of the vehicle is partially restricted, and controls, after the approval of the code information, automated driving traveling of the vehicle 1 by canceling the restriction of the automated driving function.

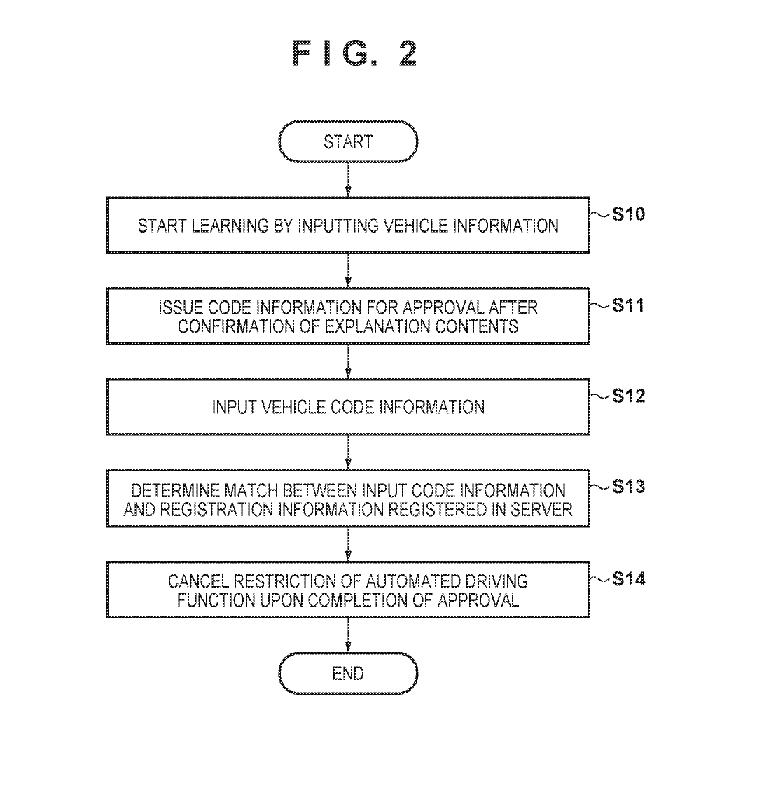

FIG. 2 is a flowchart for explaining a schematic procedure of canceling the function restriction of the automated driving function. In step S10, the user of the vehicle 1 starts learning (prior explanation) about the automated driving function by inputting vehicle information. In step S11, after confirmation of explanation contents, code information for approval is issued. In step S12, the code information is input to the vehicle. In step S13, it is confirmed whether the code information matches the registration information registered in the server. If the code information matches the registration information registered in the server, the process advances to step S14, in which the code information is approved and the restriction of the automated driving function is canceled.

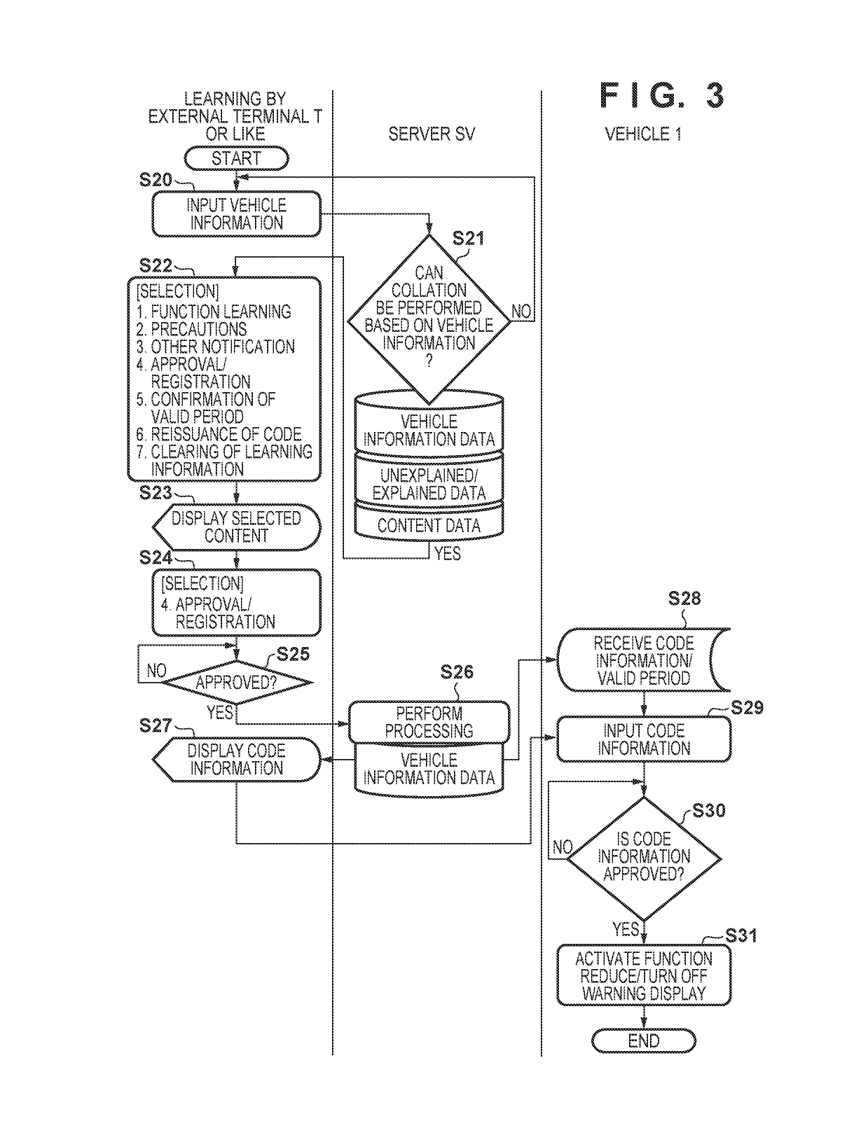

FIG. 3 is a flowchart for explaining a procedure of canceling the function restriction of the automated driving function at the time of purchase of the vehicle or the like. Learning by the external terminal T or the like includes, for example, a prior explanation (learning) by an external terminal such as a PC, a smartphone, a terminal apparatus installed in a store, or the like, that is connected to the network NET.

In step S20, if vehicle information is input from the external terminal T, this information is transmitted to the server SV. In the server SV, vehicle information data, data (unexplained/explained) representing an explanation providing status, and content data classified into various categories are registered. If it is impossible to perform collation based on the vehicle information (NO in step S21), the process returns to step S20. On the other hand, if it is determined in step S21 that collation can be performed based on the input vehicle information (YES in step S21), the process advances to step S22.

In step S22, various content data are provided from the server SV to the external terminal T. In step S23, display processing of a selected content is performed. In step S24, information concerning item 4 “approval/registration” is displayed.

In step S25, the external terminal T performs approval determination. As a precondition for approval, learning (prior explanation: “1. function learning” in step S22) about the automated driving function needs to be complete.

If learning about the automated driving function is complete and input of a valid period is confirmed (YES in step S25), the process advances to step S26.

On the other hand, if it is determined in step S25 that learning about the automated driving function is incomplete (NO in step S25), the approval determination processing in step S25 is in a learning completion waiting state.

In step S26, the server SV performs processing based on the result of the approval determination processing transmitted from the external terminal T, issues code information based on the vehicle information data, and transmits the code information to the external terminal T and the vehicle.

In step S27, the external terminal T displays the code information received from the server SV, and provides the code information to the vehicle. The vehicle inputs the code information using the input device 93 or the operation unit UI (step S29).

In step S28, the vehicle 1 receives the code information transmitted from the server SV and the valid period of the code information. The code information transmitted from the server SV is the same information as the registration information registered in the database of the server SV.

In step S30, approval processing is performed based on comparison of the code information. The ECU 28 that controls the input/output device 9 performs the approval processing. The ECU 28 approves the code information based on comparison between the registration information (the code information transmitted from the server SV) registered in the server SV on the network and the code information input from the external terminal T. If the code information input from the external terminal T does not match the registration information (the code information transmitted from the server SV) (NO in step S30), the code information is not approved and the vehicle stands by for input of correct code information.

On the other hand, if it is determined in the approval processing in step S30 that the code information input from the external terminal T matches the registration information (the code information transmitted from the server SV) (YES in step S30), the code information is approved, and the process advances to step S31.

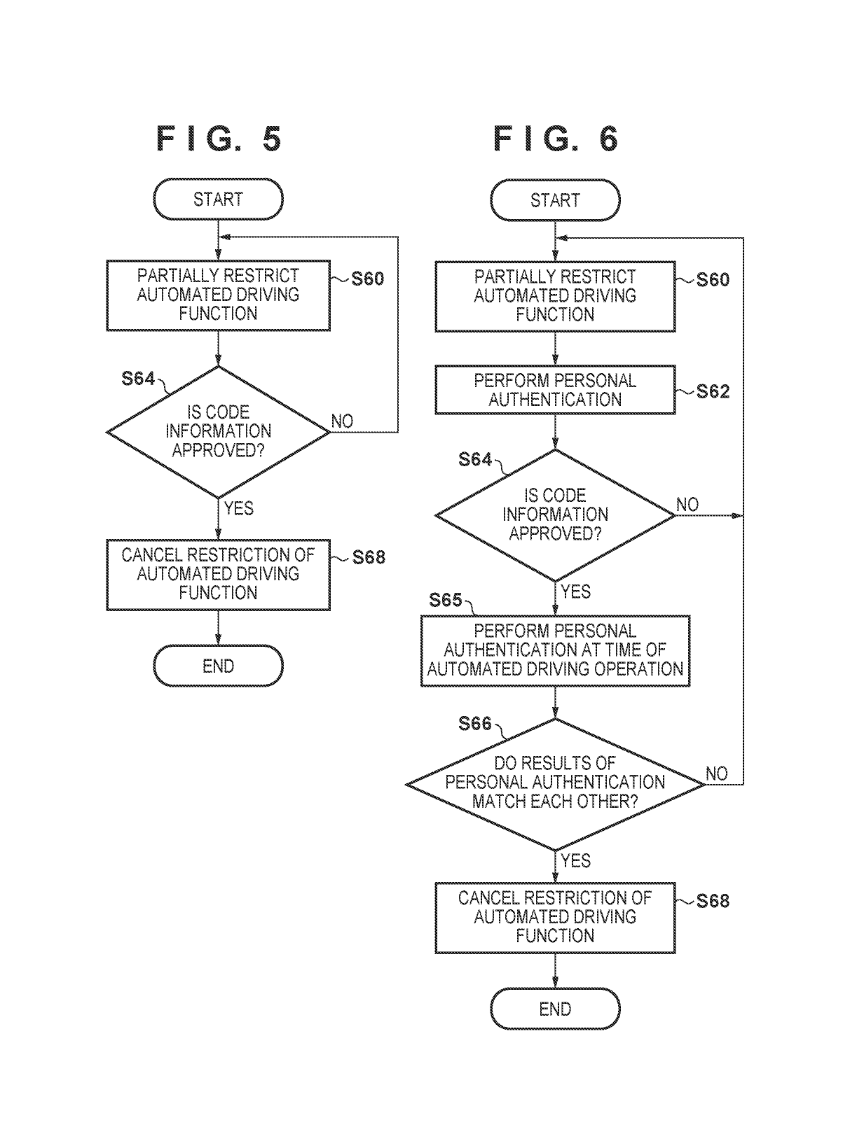

In step S31, the restriction of the automated driving function is canceled (function activation). If the restriction of the automated driving function is canceled, display control of warning display is switched. For example, the display frequency is decreased or warning display is automatically deleted. The ECU 20 that executes vehicle control associated with automated driving of the vehicle 1 performs the processing in step S31. In the processes in steps S30 and S31, the vehicle control apparatus according to this embodiment changes control of the ECU 20 before and after the approval of the code information. Detailed contents of control of the ECU 20 will be described later with reference to FIG. 5. The above processing cancels the function restriction of the automated driving function.

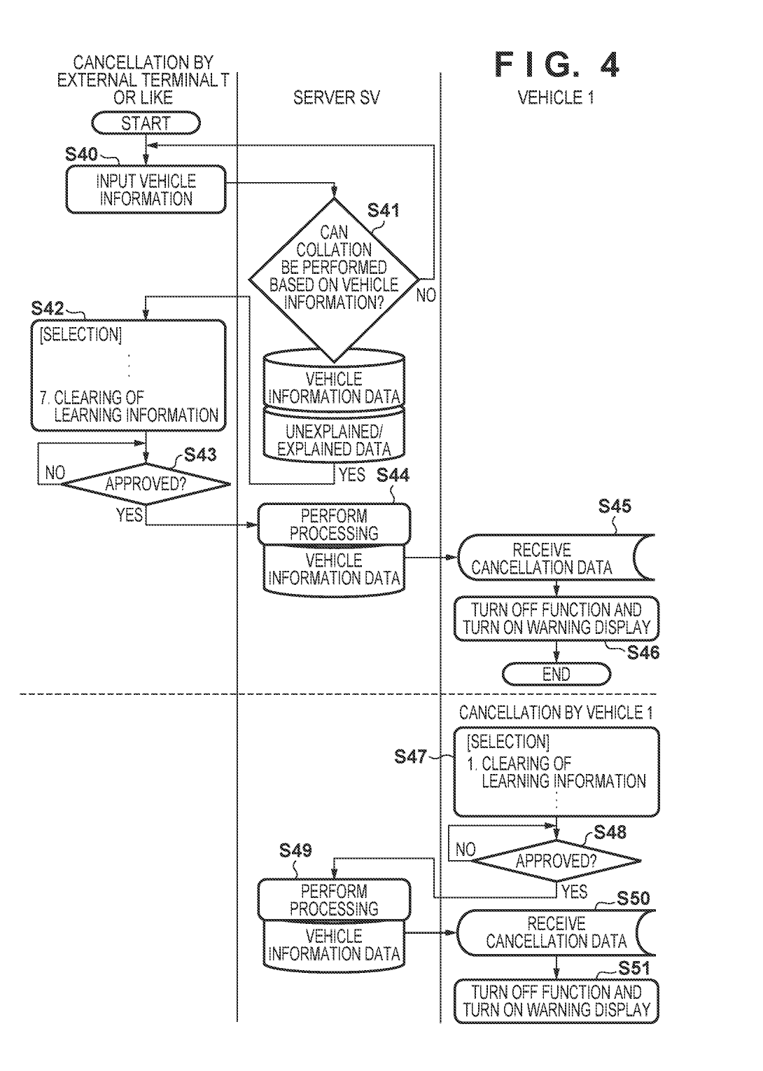

The procedure of processing of canceling the approval of the code information will be described next with reference to FIG. 4. The processing of canceling the approval of the code information is necessary when, for example, selling or transferring the vehicle.

Cancellation by the external terminal T or the like includes, for example, a cancellation operation by an external terminal such as a PC, a smartphone, a terminal apparatus installed in a store, or the like, that is connected to the network NET.

In step S40, if vehicle information is input from the external terminal T, this information is transmitted to the server SV. In the server SV, vehicle information data and data (unexplained/explained) representing an explanation providing status are registered. If it is impossible to perform collation based on the vehicle information (NO in step S41), the process returns to step S40. On the other hand, if it is determined in step S41 that it is possible to perform collation based on the input vehicle information (YES in step S41), the process advances to step S42.

In step S42, content data is provided from the server SV to the external terminal T, and display processing of a selected content is performed. In step S42, information concerning item 7 “clearing of learning information” is displayed.

In step S43, the external terminal T performs approval determination. It is required to confirm whether the learning information may be cleared. If the learning information may not be cleared, the process enters a standby state in step S43; otherwise (YES in step S43), the process advances to step S44.

In step S44, the server SV performs processing based on the result of the approval determination processing transmitted from the external terminal T, issues cancellation data based on the vehicle information data, and transmits the cancellation data to the vehicle 1.

In step S45, the vehicle 1 receives the cancellation data transmitted from the server SV. The vehicle can receive the cancellation data using the input device 93 or the operation unit UI.

In step S46, the vehicle 1 partially restricts the automated driving function (function OFF). If the automated driving function is partially restricted, display control of warning display is switched. For example, the display frequency is increased or warning display is set not to be deleted unless a confirmation key is pressed. The ECU 20 that executes vehicle control associated with automated driving of the vehicle 1 performs the processing in step S46.

The above processing is cancellation processing based on a cancellation operation, for example, in the external terminal T or the like outside the vehicle. However, it is possible to perform cancellation processing of clearing the learning information using the display device 92 or DISP or the like in the vehicle.

If content data is provided from the server SV to the vehicle or the vehicle 1 has information corresponding to content data in advance, display processing of a selected content is performed on the display screen of the display device 92 or DISP in step S47. In step S47, information concerning item 1 “clearing of learning information” is displayed.

In step S48, approval determination is performed in the vehicle 1. It is required to confirm whether the learning information may be cleared. If the learning information may not be cleared, the process enters a standby state in step S48; otherwise (YES in step S48), the process advances to step S49.

In step S49, the server SV performs processing based on the result of the approval determination processing transmitted from the vehicle 1, issues cancellation data based on the vehicle information data, and transmits the cancellation data to the vehicle 1.

In step S50, the vehicle 1 receives the cancellation data transmitted from the server SV. The vehicle can receive the cancellation data using the input device 93 or the operation unit UI.

In step S51, the vehicle 1 partially restricts the automated driving function (function OFF). If the automated driving function is partially restricted, display control of warning display is switched. For example, the display frequency is increased or warning display is set not to be deleted unless a confirmation key is pressed. The ECU 20 that executes vehicle control associated with automated driving of the vehicle 1 performs the processing in step S51.

With the above processing, the cancellation processing of clearing the learning information using the display device 92 or DISP in the vehicle ends.

<Control Processing of ECU 20>

The procedure of processing of changing control of the ECU 20 before and after the approval of the code information will be described next with reference to FIG. 5.

Step S60 is control of the ECU 20 before the approval of the code information, and the ECU 20 partially restricts the automated driving function.

In step S64, the ECU 28 performs the approval processing of the code information. This processing corresponds to the processing in step S13 of FIG. 2 or step S30 of FIG. 3 described above. In step S64, the code information is approved based on comparison between the registration information in the server SV and the code information input from the external terminal T or the like to the vehicle 1. If the input code information does not match the registration information (NO in step S64), the process returns to step S60, and the ECU 20 maintains the state in which the automated driving function is partially restricted.

On the other hand, if it is determined in the approval processing in step S64 that the code information input from the external terminal T matches the registration information (YES in step S64), the code information is approved and the process advances to step S68.

In step S68, the ECU 20 cancels the restriction of the automated driving function. This processing corresponds to the processing in step S14 of FIG. 2 or step S31 of FIG. 3 described above.

The partial restriction of the automated driving function and the cancellation in steps S60 and S68 of FIG. 5 include the following operations.

(Restriction on Automated Driving Level)

In the restriction on the automated driving level, for example, in step S60, in the state before the approval of the code information, the ECU 20 controls the vehicle 1 by restricting the automated driving level to that (for example, levels 1 and 2) in which the driver of the vehicle 1 is required to perform the peripheral monitoring duty among the plurality of automated driving levels (for example, levels 1 to 4 described above).

In step S68, the ECU 20 cancels the function restriction and, after the approval of the code information, controls automated driving traveling of the vehicle 1 by enabling all the plurality of automated driving levels (for example, levels 1 to 4).

(Restriction on Display of Notice Information for Calling Attention)

In the restriction on display of notification information for calling attention, for example, in step S60, in the state before the approval of the code information, the ECU 20 performs display control to display notice information for calling attention of the driver on the display device 92 or DISP at the first frequency, and to display the display on the display device 92 or DISP until a predetermined confirmation operation is input from the input device 93 or the operation unit UI. For example, until a confirmation key displayed on a screen is pressed, the notice information is displayed.

On the other hand, in step S68, after the approval of the code information, the ECU 20 performs display control of the display device 92 or DISP to display the notice information on the display device 92 or DISP at the second frequency lower than the first frequency, and to delete the display of the notice information after a predetermined time elapses since the display. The display of the notice information is automatically deleted without pressing the confirmation key displayed on the screen.

(Restriction on Lane Change Control)

In the restriction on lane change control, for example, in step S60, in the state before the approval of the code information, the ECU 20 controls the vehicle 1 by restricting lane change by the automated driving function. In step S68, after the approval of the code information, the ECU 20 controls automated driving traveling of the vehicle 1 by enabling lane change by the automated driving function.

(Restriction on Traveling Road Guide)

In the restriction on a traveling road guide, for example, in step S60, in the state before the approval of the code information, the ECU 20 controls the vehicle 1 by restricting traveling to that along a road on a lane on which the vehicle 1 travels. In step S68, after the approval of the code information, the ECU 20 controls automated driving traveling of the vehicle 1 by enabling the traveling road guide to a set destination.

(Restriction on Traveling Distance or Traveling Section)

In the restriction on a traveling distance or a traveling section, for example, in step S60, in the state before the approval of the code information, the ECU 20 controls the vehicle 1 by restricting traveling of a predetermined distance or traveling only in a section on a traveling road to automated driving. In step S68, after the approval of the code information, the ECU 20 controls automated driving traveling of the vehicle 1 by canceling the restriction on the distance or section.

(Restriction on Traveling Area)

In the restriction on a traveling area, in step S60, in the state before the approval of the code information, the ECU 20 controls the vehicle 1 by restricting traveling in a predetermined area to automated driving, for example, automated driving in an area other than Metropolitan Expressway. In step S68, after the approval of the code information, the ECU 20 controls automated driving traveling of the vehicle 1 by canceling the restriction on traveling in the limited area.

<Control Processing of ECU 20 by Combining Result of Personal Authentication>

In the processing shown in FIG. 5, the example in which the ECU 20 changes control contents based on the approval processing of the code information has been explained. However, as shown in FIG. 6, personal information authentication processing may be combined with the processing shown in FIG. 5. In FIG. 6, the same step numbers as in FIG. 5 denote basically the same processes as in FIG. 5 and a description thereof will be omitted. Different processes will be described.

In step S62, the ECU 28 performs personal authentication of the user before the approval of the code information. In step S64, the code information is approved based on the input code information and the result of the personal authentication in step S62. If one of the code information and the result of the personal authentication does not match the registration information (NO in step S64), the process returns to step S60, and the ECU 20 maintains the state in which the automated driving function is partially restricted.

On the other hand, if it is determined in step S64 that both the code information and the result of the personal authentication match the registration information (YES in step S64), the process advances to step S65.

In step S65, the ECU 20 further performs personal authentication of the user at the time of an automated driving operation after the approval of the code information. In step S66, the ECU 28 compares the result (S62) of the personal authentication before the approval of the code information with the result (S65) of the personal authentication of the user after the approval of the code information, and if the results of the personal authentication do not match each other, the process returns to step S60, and the ECU 20 maintains the state in which the automated driving function is partially restricted.

On the other hand, if the results of the personal authentication match each other (YES in step S66), the process advances to step S68. In step S68, the ECU 20 cancels the restriction of the automated driving function.

As the personal authentication in steps S62 and S65, the ECU 28 can register electronic authentication information concerning an authorized user of the vehicle 1 in the memory C2, and performs authentication determination of whether a driver is the authorized user, based on comparison between the electronic authentication information registered in advance in the memory C2 and an electronic key held by the driver or transmission information transmitted from a mobile terminal (smartphone or the like) to the communication device (for example, 24c) of the vehicle 1.

Alternatively, the ECU 28 can register, as a collation gesture, the behavior habit of the authorized user of the vehicle 1 in the memory C2, and perform authentication determination of whether a driver is the authorized user, based on comparison between the collation gesture registered in the memory C2 and the behavior habit of the driver extracted from the behavior of the driver captured by an in-vehicle camera 90.

Alternatively, the ECU 28 can register, as biological information of the authorized user of the vehicle 1, at least one of pieces of information of the fingerprint, voice, and face of the user in the memory C2, and perform authentication determination of whether a driver is the authorized user, based on comparison of information of the fingerprint or voice of the driver input from the input device (for example, 93 or UI) and information of the face of a driver captured by the in-vehicle camera 90 with the information registered in the memory C2.

<Control Processing of Maintaining Partial Restriction Until Predetermined Time Elapses after Approval of Code Information>

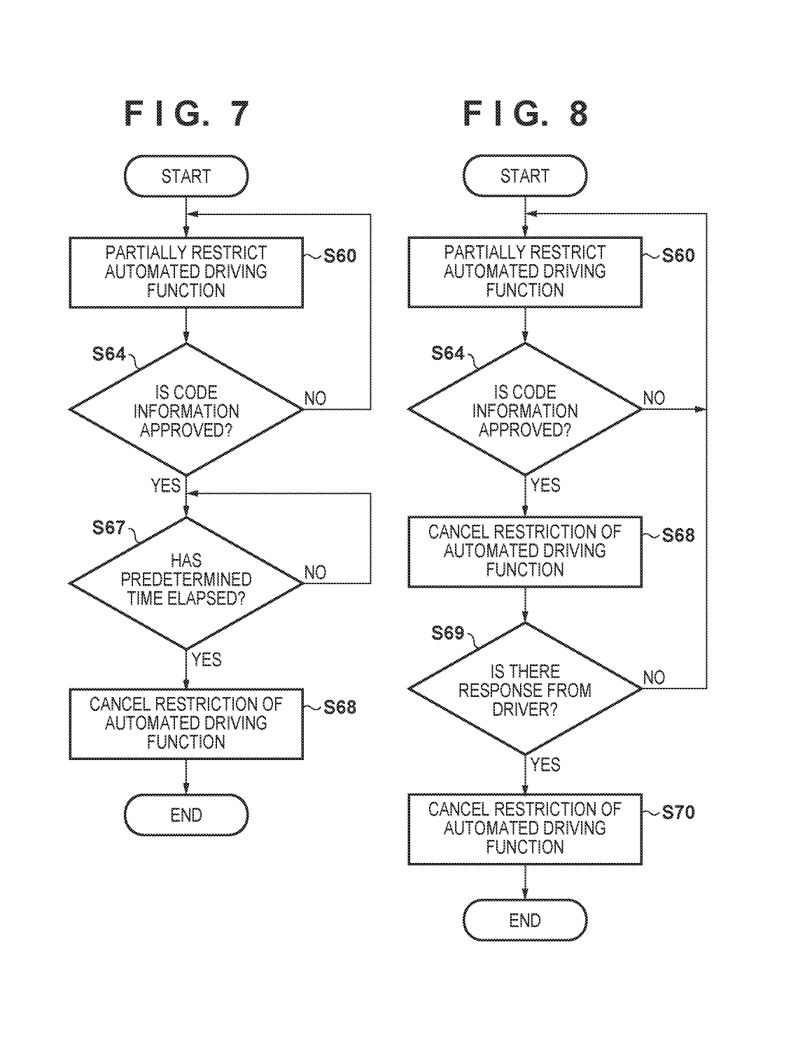

In the processing shown in FIG. 5, the example in which the ECU 20 changes control contents based on the approval processing of the code information has been explained. However, as shown in FIG. 7, the ECU 20 can perform control processing to maintain the partial restriction until a predetermined time elapses after the approval of the code information. In FIG. 7, the same step numbers as in FIG. 5 denote basically the same processes as in FIG. 5 and a description thereof will be omitted. Different processing will be described.

In step S67, the ECU 20 controls the vehicle 1 in the state in which the automated driving function of the vehicle 1 is partially restricted until a predetermined time elapses (NO in step S67) after the approval of the code information. After the predetermined time elapses (YES in step S67), the ECU 20 cancels the restriction of the automated driving function, thereby controlling automated driving traveling of the vehicle 1. In the control processing by the ECU 20, after the approval, by continuing the state, in which the automated driving function is partially restricted, until the user gets used to the automated driving function, it is possible to smoothly transit from the state in which the function is partially restricted to a state after the function restriction is canceled.

<Control in Case in which there is No Response from Driver for Predetermined Time after Function Restriction is Canceled>

In the processing shown in FIG. 5, the example in which the ECU 20 changes control contents based on the approval processing of the code information has been explained. However, as shown in FIG. 8, if there is no response from the driver for a predetermined time after the function restriction is canceled, the ECU 20 can perform control processing to partially restrict the automated driving function. In FIG. 8, the same step numbers as in FIG. 5 denote basically the same processes as in FIG. 5 and a description thereof will be omitted. Different processes will be described.

After the restriction of the automated driving function is canceled in processing in step S68, the ECU 20 determines, in step S69, the presence/absence of a response from the driver. For example, when the vehicle 1 arrives at a destination by automated driving and thus the vehicle control apparatus 100 requests to change driving or when it becomes impossible to continue automated driving due to a change in peripheral status of the vehicle 1, the vehicle control apparatus 100 may output a driving change request to the user. When a driving change request is output to the driver during automated driving traveling by the automated driving function after the approval of the code information, if there is no response to the driving change request within a preset time (NO in step S69), the process returns to step S60, and the ECU 20 controls the vehicle 1 in the state in which the automated driving function of the vehicle 1 is partially restricted. If there is a response to the driving change request (YES in step S69), the ECU 20 maintains the state in which the restriction of the automated driving function is canceled.

In the control processing of the ECU 20, it is possible to cancel the restriction of the automated driving function again when the driver receives the explanation about the automated driving function again after returning to the state in which the automated driving function is partially restricted.

<Example of Cancellation of Approval>

The processing of canceling the approval from the external terminal T, the display device 92 of the vehicle 1, or the like has been described with reference to FIG. 3. For example, the server SV on the network NET issues cancellation data for canceling the approval. If the input device 93 accepts input of the cancellation data for canceling the approval after the approval of the code information, the ECU 28 can cancel the approval based on the input of the cancellation data, and the ECU 20 can return, based on the cancellation of the approval, the state to the state in which the automated driving function of the vehicle 1 is partially restricted.

In addition to this example, for example, if the automated driving function has not operated beyond a predetermined distance or time after the approval of the code information, the ECU 20 can return the state to the state in which the automated driving function of the vehicle 1 is partially restricted.

If, based on the result of the personal authentication after the approval of the code information, a different driver drives the vehicle 1 a predetermined number of times or more, the ECU 20 can return the state to the state in which the automated driving function of the vehicle 1 is partially restricted.

Alternatively, if a control program of controlling the processing of the ECU 20 is changed by, for example, upgrading the version after the approval of the code information, the ECU 20 can return the state to the state in which the automated driving function of the vehicle 1 is partially restricted.

### Other Embodiments

Several preferred embodiments have been described above. However, the present invention is not limited to these examples and may partially be modified without departing from the scope of the invention. For example, another element may be combined with the contents of each embodiment in accordance with the object, application purpose, and the like. Part of the contents of a certain embodiment may be combined with the contents of another embodiment. In addition, individual terms described in this specification are merely used for the purpose of explaining the present invention, and the present invention is not limited to the strict meanings of the terms and can also incorporate their equivalents.

Furthermore, a program that implements at least one function described in each embodiment is supplied to a system or an apparatus via a network or a storage medium, and at least one processor in the computer of the system or the apparatus can read out and execute the program. The present invention can be implemented by this form as well.

<Summary of Embodiment>

Arrangement 1. A vehicle control apparatus according to the above embodiment is a vehicle control apparatus (for example, 100) that controls traveling of a vehicle (for example, 1) based on an automated driving function, comprising:

an input unit (for example, 93, UI) configured to input code information issued after a user of the vehicle (1) confirms an explanation about the automated driving function;

an approval unit (for example, 28, COM) configured to approve the code information based on comparison between the input code information and registration information registered in a server on a network; and a control unit (for example, 20, COM) configured to control, in a state before the approval of the code information, the vehicle in a state in which the automated driving function of the vehicle is partially restricted, and control, after the approval of the code information, automated driving traveling of the vehicle by canceling the restriction of the automated driving function.

In the vehicle control apparatus according to arrangement 1, it is possible to control, in a state before approval of an authentication code, the vehicle in the state in which the automated driving function of the vehicle is partially restricted, and control, after the approval of the code information, automated driving traveling of the vehicle by canceling the restriction of the automated driving function. Furthermore, in the vehicle control apparatus according to arrangement 1, in the state before the approval of the authentication code, it is possible to provide a minimum function while preventing overconfidence of the control apparatus that manages automated driving control, by partially restricting the automated driving function.

Arrangement 2. In the vehicle control apparatus (100) according to the above embodiment, the control unit (20, COM)

controls, in the state before the approval of the code information, the vehicle (1) by restricting an automated driving level to an automated driving level (for example, levels 1 and 2) in which a driver of the vehicle is required to perform a peripheral monitoring duty among a plurality of automated driving levels (for example, levels 1 to 4), and

controls, after the approval of the code information, automated driving traveling of the vehicle (1) by enabling all the plurality of automated driving levels (for example, levels 1 to 4).

Arrangement 3. In the vehicle control apparatus (100) according to the above embodiment, the control unit (20, COM) performs, in the state before the approval of the code information, display control to display notice information for calling attention of a driver on a display unit (for example, 92, DISP) at a first frequency, and display the display on the display unit (92, DISP) until a predetermined confirmation operation is input from the input unit (93, UI), and

performs, after the approval of the code information, display control of the display unit (92, DISP) to display the notice information on the display unit (92, DISP) at a second frequency lower than the first frequency, and delete the display of the notice information after a predetermined time elapses since the display.

Arrangement 4. In the vehicle control apparatus (100) according to the above embodiment, the control unit (20, COM) controls, in the state before the approval of the code information, the vehicle (1) by restricting lane change by the automated driving function, and controls, after the approval of the code information, automated driving traveling of the vehicle (1) by enabling lane change by the automated driving function.

Arrangement 5. In the vehicle control apparatus (100) according to the above embodiment, the control unit (20, COM) controls, in the state before the approval of the code information, the vehicle by restricting traveling to traveling along a road on a lane on which the vehicle (1) travels, and controls, after the approval of the code information, automated driving traveling of the vehicle (1) by enabling a traveling road guide to a set destination.

Arrangement 6. In the vehicle control apparatus (100) according to the above embodiment, the control unit (20, COM) controls, in the state before the approval of the code information, the vehicle (1) by restricting one of traveling of a predetermined distance and traveling only in a section on a traveling road to automated driving, and controls, after the approval of the code information, automated driving traveling of the vehicle (1) by canceling the restriction on one of the distance and the section.

Arrangement 7. In the vehicle control apparatus (100) according to the above embodiment, the control unit (20, COM) controls, in the state before the approval of the code information, the vehicle by restricting traveling in a predetermined area to automated driving, and controls, after the approval of the code information, automated driving traveling of the vehicle by canceling the restriction on traveling in the area.

In the vehicle control apparatus according to each of arrangements 2 to 7, before the approval, it is possible to appropriately restrict the more advanced automated driving function.

Arrangement 8. In the vehicle control apparatus (100) according to the above embodiment, the approval unit (28, COM)

performs personal authentication of the user before the approval of the code information to perform the approval based on the input code information and a result of the personal authentication, and

further performs personal authentication of the user at the time of an automated driving operation after the approval of the code information, and

if the result of the personal authentication before the approval of the code information does not match a result of the personal authentication of the user after the approval of the code information,

the control unit (20, COM) controls the vehicle in the state in which the automated driving function is partially restricted.

In the vehicle control apparatus according to arrangement 8, it is possible to prevent, after the approval, another person who has not received the explanation about the automated driving function from spoofing the authorized user and driving the vehicle in which the restriction of the automated driving function has been canceled.

Arrangement 9. In the vehicle control apparatus (100) according to the above embodiment, the control unit (20, COM)

controls, before a predetermined time elapses after the approval of the code information, the vehicle (1) in the state in which the automated driving function of the vehicle is partially restricted, and

controls, after the time elapses, automated driving traveling of the vehicle (1) by canceling the restriction of the automated driving function.

In the vehicle control apparatus according to arrangement 9, after the approval, by continuing the state, in which the automated driving function is partially restricted, until the user gets used to the automated driving function, it is possible to smoothly transit from the state in which the function is partially restricted to a state after the function restriction is canceled.

Arrangement 10. In the vehicle control apparatus (100) according to the above embodiment, as the personal authentication, the approval unit (28, COM) registers electronic authentication information concerning an authorized user of the vehicle (1) in a memory (for example, C2), and

performs authentication determination of whether a driver is the authorized user, based on comparison between the electronic authentication information registered in advance in the memory (C2) and one of an electronic key held by the driver and transmission information transmitted from a mobile terminal to a communication device (for example, 24c) of the vehicle (1).

Arrangement 11. In the vehicle control apparatus (100) according to the above embodiment, the approval unit (28, COM) registers, as a collation gesture, a behavior habit of an authorized user of the vehicle (1) in a memory (for example, C2), and

performs authentication determination of whether a driver is the authorized user, based on comparison between the collation gesture registered in the memory (C2) and a behavior habit of the driver extracted from a behavior of the driver captured by an in-vehicle camera (for example, 90).

Arrangement 12. In the vehicle control apparatus (100) according to the above embodiment, the approval unit (28, COM) registers, as biological information of an authorized user of the vehicle (1), at least one of pieces of information of a fingerprint, a voice, and a face of the user in a memory (for example, C2), and

performs authentication determination of whether a driver is the authorized user, based on comparison of information of one of a fingerprint and a voice of the driver input from an input device (for example, 93, UI) and information of a face of the driver captured by an in-vehicle camera with the information registered in the memory (C2).

In the vehicle control apparatus according to each of arrangements 10 to 12, it is possible to perform authentication determination of whether the driver is the authorized user.

Arrangement 13. In the vehicle control apparatus (100) according to the above embodiment, the server (for example, SV) on the network (for example, NET) issues the code information after the user confirms the explanation about the automated driving function, and

the input unit (93, UI) inputs, by communication via the network, the code information issued by the server.

In the vehicle control apparatus according to arrangement 13, it is possible to issue the code information after the user confirms the explanation about the automated driving function.

Arrangement 14. In the vehicle control apparatus (100) according to the above embodiment, if the input unit (93, UI) accepts input of cancellation data for canceling the approval, the approval unit (28, COM) cancels the approval based on the input of the cancellation data, and

the control unit (20, COM) controls, based on the cancellation of the approval, the vehicle (1) in the state in which the automated driving function of the vehicle (1) is partially restricted.

In the vehicle control apparatus according to arrangement 14, if the user is changed after the approval, it is possible to return, by canceling the approval, the state to the state in which the function is partially restricted.

Arrangement 15. In the vehicle control apparatus (100) according to the above embodiment, if, after the approval of the code information, the automated driving function has not operated beyond one of a predetermined distance and a predetermined time, the control unit (20, COM) controls the vehicle (1) in the state in which the automated driving function of the vehicle (1) is partially restricted.

Arrangement 16. In the vehicle control apparatus (100) according to the above embodiment, if, based on the result of the personal authentication after the approval of the code information, a different driver drives the vehicle not less than a predetermined number of times, the control unit (20, COM) controls the vehicle (1) in the state in which the automated driving function of the vehicle is partially restricted.

Arrangement 17. In the vehicle control apparatus (100) according to the above embodiment, the server (SV) on the network (NET) issues cancellation data for canceling the approval,

if, after the approval of the code information, the input unit (93, UI) accepts input of the cancellation data for canceling the approval, the approval unit (28, COM) cancels the approval based on the input of the cancellation data, and

based on the cancellation of the approval, the control unit (20, COM) controls the vehicle (1) in the state in which the automated driving function of the vehicle (1) is partially restricted.

Arrangement 18. In the vehicle control apparatus (100) according to the above embodiment, if a control program of controlling processing of the control unit is changed after the approval of the code information, the control unit (20, COM) controls the vehicle (1) in the state in which the automated driving function of the vehicle is partially restricted.

In the vehicle control apparatus according to each of arrangements 15 to 18, it is possible to return the state to the state in which the function is partially restricted in accordance with the use state of the vehicle or various statuses after the approval such as a case in which a plurality of drivers use the vehicle, a case in which the vehicle is transferred to another person, and a case in which the version of the control program is upgraded.

Arrangement 19. In the vehicle control apparatus (100) according to the above embodiment, when a driving change request is output to a driver during automated driving traveling by the automated driving function after the approval of the code information, if there is no response to the driving change request within a preset time, the control unit (20, COM) controls the vehicle (1) in the state in which the automated driving function of the vehicle (1) is partially restricted.

In the vehicle control apparatus according to arrangement 19, if the vehicle control apparatus outputs a driving change request to a driver and the driver does not respond to the request, the vehicle control apparatus returns the state to the state in which the automated driving function is partially restricted. To cancel the restriction of the automated driving function, the driver needs to receive an explanation about the automated driving function again. According to arrangement 19, it is possible to create a mechanism in which the driver receives an explanation about the automated driving function.

Arrangement 20. A vehicle (for example, 1) according to the above embodiment comprises a vehicle control apparatus defined in any one of arrangements 1 to 19.

In the vehicle according to arrangement 20, there is provided a vehicle that can cause the vehicle control apparatus of the vehicle to control, in a state before approval of an authentication code, the vehicle in a state in which an automated driving function of the vehicle is partially restricted, and control, after the approval of the code information, automated driving traveling of the vehicle by canceling the restriction of the automated driving function.

Arrangement 21. A vehicle control method according to the above embodiment is a vehicle control method executed by a vehicle control apparatus that controls traveling of a vehicle based on an automated driving function, comprising:

an input step of inputting code information issued after a user of the vehicle confirms an explanation about the automated driving function;

an approval step of approving the code information based on comparison between the input code information and registration information registered in a server on a network; and

a control step of controlling, in a state before the approval of the code information, the vehicle in a state in which the automated driving function of the vehicle is partially restricted, and controlling automated driving traveling of the vehicle by canceling the restriction of the automated driving function after the approval of the code information.

In the vehicle control method according to arrangement 21, it is possible to control, in the state before the approval of the authentication code, the vehicle in the state in which the automated driving function of the vehicle is partially restricted, and control, after the approval of the code information, automated driving traveling of the vehicle by canceling the restriction of the automated driving function. Furthermore, in the vehicle control method according to arrangement 21, in the state before the approval of the authentication code, it is possible to provide a minimum function while preventing overconfidence of the control apparatus that manages automated driving control, by partially restricting the automated driving function.

Arrangement 22. A storage medium according to the above embodiment causes a computer to execute each step of a vehicle control method defined in arrangement 21.

In the storage medium according to arrangement 22, it is possible to implement the vehicle control method defined in arrangement 21 by the computer. That is, it is possible to control, in a state before the approval of an authentication code, the vehicle in the state in which the automated driving function of the vehicle is partially restricted, and control automated driving traveling of the vehicle by canceling the restriction of the automated driving function after the approval of the code information. Furthermore, in the storage medium according to arrangement 22, in the state before the approval of the authentication code, it is possible to provide a minimum function while preventing overconfidence of the control apparatus that manages automated driving control, by partially restricting the automated driving function.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-156632, filed Aug. 14, 2017, which is hereby incorporated by reference wherein in its entirety.

What is claimed is:

1. A vehicle control apparatus that controls traveling of a vehicle based on an automated driving function, comprising:
an input unit configured to input code information issued after a user of the vehicle confirms an explanation about the automated driving function;
an approval unit configured to approve the code information based on comparison between the input code information and registration information registered in a server on a network; and
a control unit configured to control, in a state before the approval of the code information, the vehicle in a state in which the automated driving function of the vehicle is partially restricted, and control, after the approval of the code information, automated driving traveling of the vehicle by canceling the restriction of the automated driving function.

2. The apparatus according to claim 1, wherein the control unit
controls, in the state before the approval of the code information, the vehicle by restricting an automated driving level to an automated driving level in which a driver of the vehicle is required to perform a peripheral monitoring duty among a plurality of automated driving levels, and
controls, after the approval of the code information, automated driving traveling of the vehicle by enabling all the plurality of automated driving levels.

3. The apparatus according to claim 1, wherein the control unit performs, in the state before the approval of the code information, display control to display notice information for calling attention of a driver on a display unit at a first frequency, and display the display on the display unit until a predetermined confirmation operation is input from the input unit, and
performs, after the approval of the code information, display control of the display unit to display the notice information on the display unit at a second frequency lower than the first frequency, and delete the display of the notice information after a predetermined time elapses since the display.

4. The apparatus according to claim 1, wherein the control unit controls, in the state before the approval of the code information, the vehicle by restricting lane change by the automated driving function, and controls, after the approval of the code information, automated driving traveling of the vehicle by enabling lane change by the automated driving function.

5. The apparatus according to claim 1, wherein the control unit controls, in the state before the approval of the code information, the vehicle by restricting traveling to traveling along a road on a lane on which the vehicle travels, and controls, after the approval of the code information, automated driving traveling of the vehicle by enabling a traveling road guide to a set destination.

6. The apparatus according to claim 1, wherein the control unit controls, in the state before the approval of the code information, the vehicle by restricting one of traveling of a predetermined distance and traveling only in a section on a traveling road to automated driving, and controls, after the approval of the code information, automated driving traveling of the vehicle by canceling the restriction on one of the distance and the section.

7. The apparatus according to claim 1, wherein the control unit controls, in the state before the approval of the code information, the vehicle by restricting traveling in a predetermined area to automated driving, and controls, after the approval of the code information, automated driving traveling of the vehicle by canceling the restriction on traveling in the area.

8. The apparatus according to claim 1, wherein the approval unit
performs personal authentication of the user before the approval of the code information to perform the approval based on the input code information and a result of the personal authentication, and
further performs personal authentication of the user at the time of an automated driving operation after the approval of the code information, and
if the result of the personal authentication before the approval of the code information does not match a result of the personal authentication of the user after the approval of the code information,
the control unit controls the vehicle in the state in which the automated driving function is partially restricted.

9. The apparatus according to claim 1, wherein the control unit
controls, before a predetermined time elapses after the approval of the code information, the vehicle in the state in which the automated driving function of the vehicle is partially restricted, and
controls, after the time elapses, automated driving traveling of the vehicle by canceling the restriction of the automated driving function.

10. The apparatus according to claim 8, wherein as the personal authentication, the approval unit registers electronic authentication information concerning an authorized user of the vehicle in a memory, and
performs authentication determination of whether a driver is the authorized user, based on comparison between the electronic authentication information registered in advance in the memory and one of an electronic key held by the driver and transmission information transmitted from a mobile terminal to a communication device of the vehicle.

11. The apparatus according to claim 8, wherein the approval unit registers, as a collation gesture, a behavior habit of an authorized user of the vehicle in a memory, and
performs authentication determination of whether a driver is the authorized user, based on comparison between the collation gesture registered in the memory and a behavior habit of the driver extracted from a behavior of the driver captured by an in-vehicle camera.

12. The apparatus according to claim 8, wherein the approval unit registers, as biological information of an authorized user of the vehicle, at least one of pieces of information of a fingerprint, a voice, and a face of the user in a memory, and
performs authentication determination of whether a driver is the authorized user, based on comparison of information of one of a fingerprint and a voice of the driver input from an input device and information of a face of the driver captured by an in-vehicle camera with the information registered in the memory.

13. The apparatus according to claim 1, wherein the server on the network issues the code information after the user confirms the explanation about the automated driving function, and
the input unit inputs, by communication via the network, the code information issued by the server.

14. The apparatus according to claim 1, wherein if the input unit accepts input of cancellation data for canceling the approval, the approval unit cancels the approval based on the input of the cancellation data, and
the control unit controls, based on the cancellation of the approval, the vehicle in the state in which the automated driving function of the vehicle is partially restricted.

15. The apparatus according to claim 1, wherein if, after the approval of the code information, the automated driving function has not operated beyond one of a predetermined distance and a predetermined time, the control unit controls the vehicle in the state in which the automated driving function of the vehicle is partially restricted.

16. The apparatus according to claim 8, wherein if, based on the result of the personal authentication after the approval of the code information, a different driver drives the vehicle not less than a predetermined number of times, the control unit controls the vehicle in the state in which the automated driving function of the vehicle is partially restricted.

17. The apparatus according to claim 1, wherein the server on the network issues cancellation data for canceling the approval,
if, after the approval of the code information, the input unit accepts input of the cancellation data for canceling the approval, the approval unit cancels the approval based on the input of the cancellation data, and
based on the cancellation of the approval, the control unit controls the vehicle in the state in which the automated driving function of the vehicle is partially restricted.

18. The apparatus according to claim 1, wherein if a control program of controlling processing of the control unit is changed after the approval of the code information, the control unit controls the vehicle in the state in which the automated driving function of the vehicle is partially restricted.

19. The apparatus according to claim 1, wherein when a driving change request is output to a driver during automated driving traveling by the automated driving function after the approval of the code information, if there is no response to the driving change request within a preset time, the control unit controls the vehicle in the state in which the automated driving function of the vehicle is partially restricted.

20. A vehicle comprising a vehicle control apparatus defined in claim 1.

21. A vehicle control method executed by a vehicle control apparatus that controls traveling of a vehicle based on an automated driving function, comprising:
an input step of inputting code information issued after a user of the vehicle confirms an explanation about the automated driving function;
an approval step of approving the code information based on comparison between the input code information and registration information registered in a server on a network; and
a control step of controlling, in a state before the approval of the code information, the vehicle in a state in which the automated driving function of the vehicle is partially restricted, and controlling automated driving traveling of the vehicle by canceling the restriction of the automated driving function after the approval of the code information.

22. A non-transitory computer-readable storage medium storing a program for causing a computer to execute each step of a vehicle control method defined in claim 21.
